(19) United States
(12) Patent Application Publication
(10) Pub. No.: US 2024/0061829 A1
(43) Pub. Date: Feb. 22, 2024

(54) SYSTEM AND METHODS FOR ENHANCING DATA FROM DISJUNCTIVE SOURCES

(71) Applicant: Oracle International Corporation, Redwood Shores, CA (US)

(72) Inventors: Megan Rose Margraff, Trumbull, CT (US); Jason Loring Canney, Highlands Ranch, CO (US); Alexander Mark Robbe, Redwood Shores, CA (US); Richard Martin Berger, Boulder, CO (US)

(73) Assignee: Oracle International Corporation, Redwood Shores, CA (US)

(21) Appl. No.: 17/821,043

(22) Filed: Aug. 19, 2022

(51) Int. Cl. G06F 16/23

(52) U.S. Cl. CPC G06F 16/2365

(57) ABSTRACT

The present disclosure relates to systems and methods for enhancing data from disjunctive sources using a weighted interaction graph. First data about first entities can be received from a first data source. Second data about second entities at least partially different than the first entities can be received from a second data source. Relationships between each entity of the first entities and second entities can be determined, and a set of classes can be inferred from the first data and from the second data. A weighted interaction graph can be generated. The weighted interaction graph can indicate a likelihood of each entity interacting with a corresponding class. An extended set of data can be generated using the weighted interaction graph. The extended set of data can be output to facilitate communication with third entities that include the first entities and the second entities.

### TECHNICAL FIELD

The present disclosure relates to systems and methods for enhancing data from disjunctive sources. More particularly, the present disclosure relates to systems and methods that process data from disjunctive sources to generate a weighted interaction graph that is used to enhance the data.

### BACKGROUND

Stored data about a set of entities, such as individuals, households, and the like, can be large since data can be collected from different sources, can be collected in different formats, and the like. For example, a first data source can store first data in a first format that is different than a second format of second data stored in a second data source separate from the first data source. Data may be stored according to data source, data format, collection time period, etc., such that some portions of data that correspond to a given entity may be stored on a different storage device, a different storage system, a different partition, etc. relative to other portions of data that correspond to the given entity. Thus, data can be disjunctive or disparate such that accessing a complete set of the data can be difficult or impossible with a single query or even a set of queries.

When data is disjunctive, various portions of the data (e.g., that are stored on different storage systems, different storage devices, different partitions, etc. and/or that had been received from different sources; that are from different data sources; that have different data formats; that were collected during different collection time periods; etc.) may be subject to different access constraints. For example, the first data source may provide access to first data with first access constraints that are different than second access constraints associated with second data of the second data source. Accessing a union of the first data and the second data can be difficult due to the different access constraints associated with the first data and the second data.

Regardless of the constraints, a client may be interested in data that spans the portions of data. Accordingly, a client (e.g., as a data tenant, data client, or the like) may submit separate queries to the first data source and the second data source to attempt to comply with the different access constraints, but the access constraints may result in the client not being granted permission to access a complete set of the first data and/or a complete set of the second data (e.g., due to one or both of the access constraints). In this case, the client may receive incomplete data or may otherwise receive data from the first data source and the second data source that is not sufficient for operations that the client intends to perform.

### SUMMARY

In some embodiments, a computer-implemented method is provided for enhancing data from disjunctive sources. A first set of data that includes data about a first set of entities can be received from a first source of data. A second set of data that includes data about a second set of entities that is at least partially different than the first set of entities can be received by the computing device and from a second source of data that is different than the first source of data. A set of relationships between each entity of the first set of entities and the second set of entities can be determined by the computing device and based on the first set of data and the second set of data. A set of classes can be inferred from the first set of data and from the second set of data. A weighted interaction graph that indicates, for each entity of the first set of entities and the second set of entities, a likelihood of each entity interacting with a corresponding class can be generated by the computing device and using the set of relationships. An extended set of data can be generated by the computing device and using the weighted interaction graph. The extended set of data can be output to facilitate communication with a third set of entities that comprises the first set of entities and the second set of entities.

In some embodiments, the first source of data is disjunctive with respect to the second source of data.

In some embodiments, determining the set of relationships comprises, for each entity included in the first set of entities and in the second set of entities: (i) receiving, by the computing device, historical interaction data, and (ii) determining, by the computing device and using the historical interaction data, a plurality of relationships between the entity and a plurality of classes.

In some embodiments, each relationship included in the plurality of relationships includes a likelihood of the entity interacting with a corresponding class of the plurality of classes.

In some embodiments, the first set of data includes propensity-scored entities, the second set of data includes look-a-like-scored entities, and a third set of data, which includes unscored entities and that is at least partially different than the first set of data and the second set of data, can be received from a third source of data that is different than the first source of data and the second source of data.

In some embodiments, determining the set of relationships between each entity of the first set of entities and the second set of entities and the set of classes inferred from the first set of data and from the second set of data includes determining, by the computing device, the set of relationships between each entity of the first set of entities, the second set of entities, and the unscored entities and a different set of classes inferred from the first set of data, from the second set of data, and from the third set of data.

In some embodiments, the extended set of data includes interaction data not inferable separately from the first set of data and the second set of data.

In some embodiments, a computer-program product is provided that is tangibly embodied in a non-transitory machine-readable storage medium and that includes instructions configured to cause one or more data processors to perform various operation. The operations can include receiving, at a computing device and from a first source of data, a first set of data that includes data about a first set of entities. The operations can include receiving, by the computing device and from a second source of data that is different than the first source of data, a second set of data that includes data about a second set of entities that is at least partially different than the first set of entities. The operations can include determining, by the computing device and based on the first set of data and the second set of data, a set of relationships between each entity of the first set of entities and the second set of entities and a set of classes inferred from the first set of data and from the second set of data. The operations can include generating, by the computing device and using the set of relationships, a weighted interaction graph that indicates, for each entity of the first set of entities and the second set of entities, a likelihood of each entity interacting with a corresponding class. The operations can include generating, by the computing device and using the weighted interaction graph, an extended set of data. The operations can include outputting the extended set of data to facilitate communication with a third set of entities that comprises the first set of entities and the second set of entities.

In some embodiments, a system is provided that includes one or more data processors and a non-transitory computer readable storage medium including instructions which, when executed on the one or more data processors, cause the one or more data processors to perform various operations. The system can receive, from a first source of data, a first set of data that includes data about a first set of entities. The system can receive, from a second source of data that is different than the first source of data, a second set of data that includes data about a second set of entities that is at least partially different than the first set of entities. The system can determine, based on the first set of data and the second set of data, a set of relationships between each entity of the first set of entities and the second set of entities and a set of classes inferred from the first set of data and from the second set of data. The system can generate, using the set of relationships, a weighted interaction graph that indicates, for each entity of the first set of entities and the second set of entities, a likelihood of each entity interacting with a corresponding class. The system can generate, using the weighted interaction graph, an extended set of data. The system can output the extended set of data to facilitate communication with a third set of entities that comprises the first set of entities and the second set of entities.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The specification makes reference to the following appended figures, in which use of like reference numerals in different figures is intended to illustrate like or analogous components.

FIG. 1 is a block diagram illustrating an example of a data processing environment for enhancing data from disjunctive sources according to an embodiment.

FIG. 2 is a flowchart of a process for enhancing data originating from disjunctive sources according to an embodiment.

FIG. 3 is a flowchart of a process for generating a weighted interaction graph for entities represented by data from disjunctive sources of data according to an embodiment.

FIG. 4 is a data flow diagram of data from disjunctive sources used for generating a weighted interaction graph according to an embodiment.

FIG. 5 is a diagram of one example of a weighted interaction graph according to an embodiment.

FIG. 6 is a simplified diagram illustrating a distributed system for implementing one of the embodiments.

FIG. 7 is a simplified block diagram illustrating one or more components of a system environment according to an embodiment.

FIG. 8 illustrates an exemplary computer system, in which various embodiments of the present invention may be implemented.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Overview

Certain aspects and features of the present disclosure relate to enhancing data from disjunctive sources. The data can be received in response to a query being transmitted. The query can include values for a set of fields such that the values are stored on different data stores included in the disjunctive sources. The data can include information about a set of entities that can include users, consumers, households, or the like. In some examples, the data can include other types of data, such as data about computing devices, which can include personal computing devices, computer server systems, cloud computing systems, or the like. The disjunctive sources can include one or more data stores, one or more data repositories, one or more server networks, one or more cloud computing systems, and/or one or more other types of data stores. Accessing complete data from each source of data included in the disjunctive sources may be difficult or impossible. For example, accessing the complete data with a single query may be impossible, and accessing the complete data with multiple queries may be difficult or impossible due to access constraints, which may be different for each of the disjunctive sources. In a particular example, data from a first data source may be accessible to a computing device operated by a client (e.g., a data tenant, data client, or the like), but data from one or more other data sources that are disjunctive with the first data source may be less than fully accessible via the computing device due to access constraints of the one or more second data sources. The data from the one or more second sources may be restricted (e.g., due to personally identifiable information, due to business decisions of an operator of the one or more second disjunctive sources, etc.) based on the access constraints of the one or more second sources.

The one or more second sources can selectively provide access to the data included in the one or more second sources for the computing device. The computing device may receive incomplete access to data queried from the one or more second data sources. In a particular example, the computing device can receive access to queried interaction data stored at the one or more second data sources and associated with a set of entities, but the computing device may receive less than complete access, or no access, to queried identifying information about the set of entities due to access constraints of the one or more second data sources preventing at least some access to identifying information. In another example, the computing device may receive access to complete queried data stored at the one or more second sources and about a first portion of entities represented by the data, but the computing device may receive less than complete access, or no access, to data about a second portion of entities, which are different than the first portion, represented by the data due to access constraints of the one or more second data sources preventing at least some access to information about the second portion of entities.

Enhancing data from the disjunctive sources can involve generating a weighted interaction graph that can be used to generate an extended set of data based on data received from the disjunctive sources. The weighted interaction graph can include a graph that represents or otherwise indicates a set of relationships between entities and/or interaction classes represented by data received from the disjunctive sources. An interaction class can represent a type of interaction or indicate a potential type of interaction that can be taken by an entity. For example, an interaction class can represent a potential interest for the entity, a potential decision made by the entity, and the like. Additionally, the weighted interaction graph can indicate a likelihood of one or more entities represented by data received from the disjunctive sources interacting with a particular interaction class of the interaction classes represented by the data received from the disjunctive sources.

In some examples, the weighted interaction graph can include nodes and a set of connections. A node can represent an entity (e.g., an entity node) or an interaction class (e.g., a class node), and a connection can connect an entity node with a class node. For example, the weighted interaction graph can include a first set of nodes that includes one or more entity nodes correspond to one or more entities represented by data received from the disjunctive sources. Additionally, the weighted interaction graph can include a second set of nodes that includes one or more class nodes corresponding to interaction classes represented by the data received from the disjunctive sources. The set of connections can connect an entity node included in the first set of nodes to one or more class nodes included in the second set of nodes. Additionally, each connection included in the set of connections can indicate a likelihood of a corresponding entity interacting with a corresponding interaction class. For example, a size, shape, color, pattern, or the like of a connection connecting an entity node and a class node can be adjusted to indicate the likelihood of an entity represented by the entity node interacting with an interaction class represented by the class node.

The weighted interaction graph can be used to infer additional data and/or metadata about (i) entities that may be represented by the data received from the disjunctive sources and about (ii) entities that may not be represented by the data received from the disjunctive sources. For example, the inferred additional data can include a likelihood of an entity represented by the data interacting with an interaction class not represented by the data. Additionally, the inferred additional data can include a likelihood of an entity not represented by the data interacting with an interaction class represented by the data. Inferring the additional data can involve determining relationships between entities and/or interaction classes. For example, a relationship can be determined between a first entity and a second entity to infer a likelihood of the second entity interacting with an interaction class. Determining the relationship can involve determining similarities, such as similar interaction classes with which the entities interact, between the first entity and the second entity. A likelihood of the first entity interacting with the interaction class can be determined based on data received from disjunctive sources, but a likelihood of the second entity interacting with the interaction class may not be able to be determined based on the received data. The relationship between the first entity and the second entity can be used to infer the likelihood of the second entity interacting with the interaction class. The additional, inferred, data can be augmented to existing data to generate the extended dataset, which can be used to communicate with entities represented by the extended dataset and for other purposes.

The extended set of data may include or represent enhanced data. For example, the extended set of data may include previously missing data, previously inaccessible data, or higher-quality (e.g., more accurate or up-to-date) data relating to entities represented by first data queried from the first data source and/or second data relating to second entities represented by data queried from the one or more second data sources. Additionally or alternatively, the extended set of data can include data about third entities, which may not be represented by the first data or the second data. Stated differently, generating and using the weighted interaction graph can allow the computing device to enhance existing data by inferring more data or metadata or higher quality data or metadata about existing data or data that may be missing from data queried from disjunctive sources of data.

The computing device can output the extended set of data to facilitate communication with the first entities, the second entities, the third entities, etc. For example, the computing device can output a command based on the extended set of data to provide resources to one or more entities included in the first entities, the second entities, and/or the third entities. In a particular example, the computing device can cause computing resources, such as computer processing power, computer memory, or the like, to be allocated to a particular entity of the first entities, the second entities, the third entities, etc. based on the extended set of data. Additionally or alternatively, the computing device can output a command, in response to receiving a query or request for the extended set of data, to transmit the extended set of data for facilitating communication with the first entities, the second entities, and/or the third entities. The communication can involve an advertisement campaign, appointment reminders, event invitations, and the like.

Exemplary Environment for Enhancing Data from Disjunctive Sources

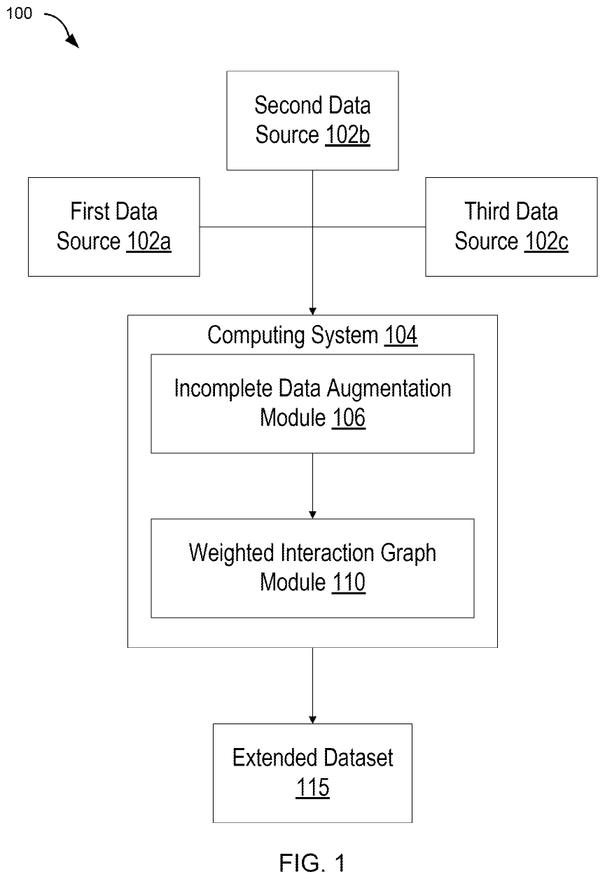

FIG. 1 is a block diagram illustrating an example of a data processing environment 100 for enhancing data from disjunctive sources according to an embodiment. As illustrated, the data processing environment 100 includes a first data source 102a, a second data source 102b, and a third data source 102c, though any other numbers (e.g., one, two, four, five, six, etc.) of data sources can be included in the data processing environment 100. In some examples, each of the first data source 102a, the second data source 102b, and the third data source 102c may be or include a database, data store, data repository, data partition, or the like that can obtain, store, or otherwise manage data relating to entities that can include users of computing devices, consumers, households, or the like.

The first data source 102a, the second data source 102b, and the third data source 102c can each be communicatively coupled to a computing system 104. Additionally, the first data source 102a may be disjunctive with the second data source 102b and/or the third data source 102c, or any permutation thereof. Disjunctive data sources may include data sources that involve different access constraints. As a result, receiving complete data from the disjunctive data sources may be difficult or impossible using a single query or even multiple queries. The first data source 102a may be disjunctive with respect to the second data source 102b such that submitting one or more queries to the first data source 102a and to the second data source 102b using the computing system 104 may result in less than complete access to data stored at the first data source 102a and the second data source 102b. In a particular example, the computing system 104 may access complete data from the first data source 102a but may access partial data (e.g., due to the access constraints of the second data source 102b) from the second data source 102b, or vice versa.

The first data source 102a, the second data source 102b, and the third data source 102c can include data about particular entities such as individuals, households, and the like. For example, the first data source 102a can include data about first entities, the second data source 102b can include data about second entities, and the third data source 102c can include data about third entities, etc. The disjunctive nature of the first data source 102a, the second data source 102b, and/or the third data source 102c can involve limited access to some or all data of some or all of the entities. For example, the computing system 104 may access complete data about first entities from the first data source 102a but may access partial data from the second data source 102b and/or the third data source 102c. In particular, the partial data from the second data source 102b can include interaction data for the second entities but may lack identifying data about the second entities, or vice versa. Additionally or alternatively, the partial data from the third data source 102c can include complete data about some entities of the third entities but may lack data about the remaining entities of the third entities, or vice versa.

The computing system 104 can receive data from one or more of the first data source 102a, the second data source 102b, and/or the third data source 102c. For example, the computing system 104 can receive first data from the first data source 102a, second data from the second data source 102b, third data from the third data source 102c, or any combination thereof. The computing system 104 may transmit a query to one or more, or each, of the first data source 102a, the second data source 102b, and/or the third data source 102c to receive respective data. In other examples, one or more of the first data source 102a, the second data source 102b, and/or the third data source 102c may transmit, for example periodically or in response to receiving external input, the respective data to the computing system 104. The received data may include incomplete data from one or more, or each, of the first data source 102a, the second data source 102b, and/or the third data source 102c.

The computing system 104 can receive the incomplete data and can provide the incomplete data to an incomplete data augmentation module 106. The incomplete data augmentation module 106 can ingest the incomplete data and can convert the incomplete data into a usable form. For example, the incomplete data augmentation module 106 can aggregate the incomplete data, can augment the incomplete data to an existing set of data, can perform other operations for pre-processing the incomplete data, or any combination thereof.

The incomplete data augmentation module 106 can provide the pre-processed data to a weighted interaction graph module 110 included in the computing system 104. The weighted interaction graph module 110 can generate a weighted interaction graph based on the output from the incomplete data augmentation module 106. For example, the weighted interaction graph module 110 can determine relationships between entities represented by the pre-processed data, can infer interaction classes (hereinafter “classes”) based on the pre-processed data, and the like. Additionally, the weighted interaction graph module 110 can use the relationships, the inferred classes, and the like to generate the weighted interaction graph, which may indicate one or more likelihoods of a particular entity interacting with one or more particular inferred classes.

The weighted interaction graph module 110 can use the weighted interaction graph to generate an extended dataset 115. For example, the weighted interaction graph module 110 can infer additional data or metadata about entities represented by the pre-processed data. A likelihood of an entity interacting with one or more classes may not exist in the pre-processed data, but the weighted interaction graph module 110 can infer, using the weighted interaction graph, the likelihood and can augment the extended dataset 115 with the likelihood. Additionally, the weighted interaction graph module 110 can infer data (e.g., the likelihood, etc.) about entities not represented by the pre-processed data. The computing system 104 can output the extended dataset 115 via the weighted interaction graph module 110.

The extended dataset 115 can be used to facilitate communication with various entities. For example, the extended dataset 115 can be output by the computing system 104 to facilitate a messaging campaign that targets the first entities, the second entities, and/or the third entities. In other examples, the extended dataset 115 can be used to provide resources to one or more entities represented by the first entities, the second entities, and/or the third entities. The resources can include computing resources, services, or any other resources that can be provided using the extended dataset 115. The computing system 104 can output a command along with the extended dataset 115 for facilitating communication, to cause the resources to be provided, and the like.

### Exemplary Process for Asynchronous Log Data Processing and Enriching

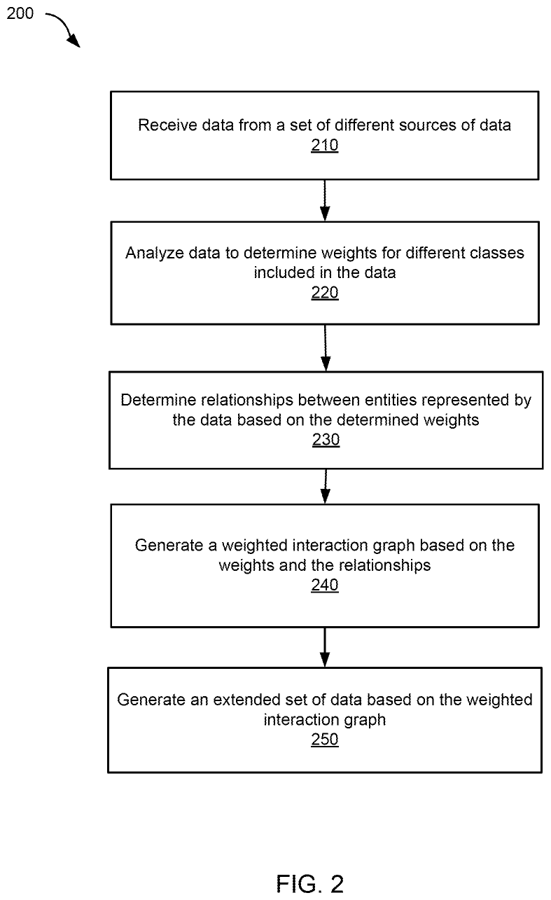

FIG. 2 is a flowchart of a process 200 for enhancing data originating from disjunctive sources according to an embodiment. The process 200 may be performed at least in part by any of the components described in the figures herein, for example, by any component of the data processing environment 100 or by the data processing environment 100, itself. The process 200 can begin at block 210, when the computing system 104 receives data from different sources. The data can be stored at disjunctive sources of data. For example, the data can include first data from a first source of data (e.g., the first data source 102a) and second data from a second source of data (e.g., the second data source 102b) that is disjunctive with respect to the first source of data, etc. The computing system 104 may not be configured to access complete data from the first source of data and the second source of data using one or more queries. Thus, the first data and/or the second data may be incomplete (e.g., missing entity identifiable data, missing data about some entities, etc.). In other examples, the first data and the second data may include complete data from the first source of data and the second source of data, respectively, but the first source of data and/or the second source of data may be disjunctive with respect to a third source of data from which the computing system 104 may receive little to no data.

At block 220, the computing system 104 analyzes the received data to determine weights for different classes included in or represented by the received data. The computing system 104 can infer a set of classes based on the received data. For example, the computing system 104 can analyze the received data and can determine that one or more classes are represented by the received data. In some examples, a class represents a particular aspect of an entity, a particular interaction taken by the entity, potential interests of the entity, etc. In a particular example, the computing system 104 can analyze the received data and determine that the set of classes includes classes relating to products or services relating to home improvement acquired by the entity, interest of the entity in travelling, a size of a family of the entity, identifying information (e.g., age, gender, and the like) of the entity, and the like.

In some examples, the received data can include one or more indications of classes. For example, the received data may include propensity-scored entities, lookalike-scored entities, personality-scored entities, other pre-processed data, or any combination thereof. Propensity-scored entities can involve a probability of one or more entities interacting with one or more classes based on an observed set of covariate. Lookalike-scored entities can involve entities scored based on how similar the entities individually are to a given class. Personality-scored entities may involve entities scored for different types of personalities or expected behaviors. Thus, data about entities in the received data may be pre-processed, and, in some examples, one or more classes may be predetermined. However, in other examples, the computing system 104 can analyze the received data to augment any predetermined classes with additional classes based on the analysis. For example, the computing system 104 can analyze historical interaction data of the entities represented in the received data, identifiable information of the entities represented in the received data, similarities in behavior, identity, and the like between entities represented in the received data, and the like to determine additional classes.

Upon determining the classes, the computing system 104 can determine weights for each class. Each weight associated with a corresponding class can indicate how likely a corresponding entity is to interact with the corresponding class. In examples in which the weights range from zero to one, a higher weight may indicate that the corresponding entity is more likely to interact with the corresponding class, and a lower weight may indicate that the corresponding entity is less likely to interact with the corresponding class. Determining the weights can involve analyzing the received data. For example, and for a given class of interest of a particular entity in travelling, the computing system 104 can determine the weight for the given class by determining how frequently the entity historically travelled, how frequently the entity historically expressed interest in travelling, etc. for determining the weight for the given class.

At block 230, the computing system 104 determines relationships between entities represented by the received data. In some examples, the computing system 104 determines the relationships based on the determined weights for the different classes. For example, the computing system 104 can compare weights for the set of classes for a first entity with weights for the set of classes for a second entity. In a particular example in which a class is not weighted with respect to a first entity, the computing system 104 can compare the first entity with a second entity (e.g., the computing system 104 can compare first data representing the first entity with second data representing the second entity) to determine the weight for the class with respect to the first entity. In this example, the weight for the first entity may be similar or different than the weight for the second entity. The computing system 104 can determine the relationships between any combination of entities represented by the received data.

At block 240, the computing system 104 generates a weighted interaction graph using the determined relationships and the determined weights. The weighted interaction graph can include various nodes and edges connecting the nodes. In some examples, the computing system 104 can generate one weighted interaction graph for each entity represented by the received data. In other examples, the computing system 104 generates one weighted graph for a set of entities that can include between two entities and all entities represented by the received data. The nodes of the weighted interaction graph can represent the entities and/or the classes associated with the entities. The edges can connect the nodes and can indicate a likelihood of a particular entity interacting with a corresponding class.

In some examples, the weighted interaction graph can include a node representing an entity and a set of nodes representing classes associated with the entity. The computing system 104 can generate the node based on the received data that represents the entity (e.g., the computing system 104 can identify the entity and can generate the node based on this identification). Additionally, the computing system 104 can generate the set of nodes based on the determined classes associated with the entity. For example, for each determined class associated with the entity, the computing system 104 can generate a node for the set of nodes. Additionally, the weighted interaction graph can include a set of edges that can connect the node representing the entity and the set of nodes representing the classes.

In some examples, the computing system 104 can generate the edges based on the weights for the entity and associated with each of the classes. For example, an edge connecting the entity node with a particular class node can represent a weight for the entity with respect to the particular class. The edge connecting the entity node with the particular class node can indicate the likelihood of the entity interacting with the particular class. For example, the computing system 104 can generate the edge to visually indicate the likelihood or may include the likelihood in the edge (e.g., the computing system 104 can include a score or other stored value that indicates the likelihood). Visually indicating the likelihood may involve adjusting a size, length, color, pattern, or any other visual indicator to indicate the likelihood. In a particular example, the computing system 104 can generate a longer edge to indicate a lower likelihood of the entity interacting with the particular class, or can generate a shorter edge to indicate a higher likelihood of the entity interacting with the particular class.

At block 250, the computing system 104 generates an extended dataset using the weighted interaction graph. The extended dataset can include data not originally included in data received (e.g., at the block 210) by the computing system 104. The computing system 104 can use the weighted interaction graph to determine or otherwise infer additional data that can be augmented to the received data to generate the extended dataset. For example, the computing system 104 can use the determined weights to infer additional data (e.g., data not previously known, accessible, and the like). In a particular example, the computing system 104 can use a weight associated with an entity and a particular class to infer additional information regarding a separate entity not represented by any received data or a separate class not presently associated with the entity.

Using the weight can involve determining a similarity between the entity and the separate entity, determining a similarity between the particular class and the separate class, and the like. For example, the computing system 104 can determine that the entity and the separate entity are similar or nearly identical and, thus, the computing system 104 can generate a similar or identical weight applied to the separate entity and the particular class. Additionally, the computing system 104 can determine that the particular class and the separate class are similar or nearly identical and, thus, the computing system 104 can generate a similar or identical weight applied to the entity and the separate class. In a particular example, the particular class can involve interest in home improvement, and the separate class may involve interest in gardening. If the weight between the entity and the particular class of interest in home improvement is high (or low), then the computing system 104 can generate a similarly high (or low) weight for the entity and the separate class of interest in gardening since the computing system 104 can determine that the particular class and the separate class are similar, related, etc. In a different example, the particular class can involve interest in home improvement, and the separate class may involve renting an apartment. If the weight between the entity and the particular class of interest in home improvement is high (or low), then the computing system 104 can generate a conversely low (or high) weight for the entity and the separate class of renting an apartment since the computing system 104 can determine that the particular class and the separate class are conversely related, etc.

### Exemplary Process for Generating a Weighted Interaction Graph

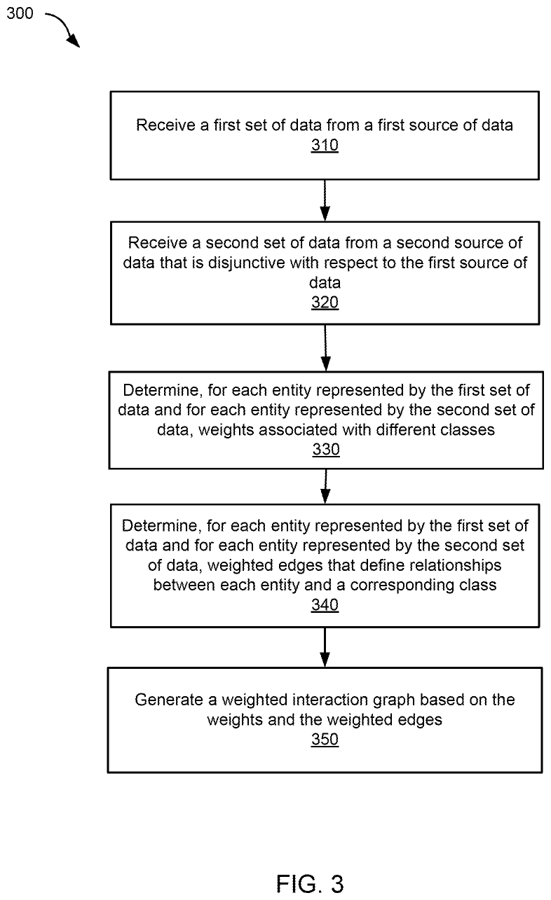

FIG. 3 is a flowchart of a process 300 for generating a weighted interaction graph for entities represented by data from disjunctive sources of data according to an embodiment. The process 300 may be performed at least in part by any of the components described in the figures herein, for example, by any component of the data processing environment 100 or by the data processing environment 100, itself. The process 300 can begin at block 310, when the computing system 104 receives a first set of data from a first source of data. The first set of data can include information about a first set of entities (e.g., users of computing devices, individuals, or households). The information can include historical interaction data for the first set of entities, identifiable information for the first set of entities, and the like. In some examples, the first set of data can include pre-processed data about the first set of entities. For example, the first set of data can include propensity-scored data about the first set of entities, lookalike-scored data about the first set of entities, and/or personality-scored data about the first set of entities.

At block 320, the computing system 104 receives a second set of data from a second source of data. In some examples, the second source of data is disjunctive with respect to the first source of data. The second set of data can include information about a second set of entities (e.g., users of computing devices, individuals, or households) that is at least partially different than the first set of entities. The information can include historical interaction data for the second set of entities, identifiable information for the second set of entities, and the like. In some examples, the second set of data can include pre-processed data about the second set of entities. For example, the second set of data can include propensity-scored data about the second set of entities, lookalike-scored data about the second set of entities, and/or personality-scored data about the second set of entities.

At block 330, the computing system 104 determines, for each entity represented by the first set of data and for each entity represented by the second set of data, weights associated with different classes. The computing system 104 can determine, identify, or otherwise infer a set of classes from the first set of data and/or the second set of data. For example, the computing system 104 can receive predetermined classes, can infer additional classes based on historical interaction data, or a combination thereof for the first set of data and/or the second set of data. The classes can represent interactions, potential interactions, interests of the entities, etc.

In some examples, the computing system 104 can determine weights for each entity represented by the first set of data and for each entity represented by the second set of data based on operations described with respect to the block 220 of the process 200. For example, determining the weights can involve analyzing the received data. For example, and for a given class of interest of a particular entity in travelling, the computing system 104 can determine the weight for the given class by determining how frequently the entity historically travelled, how frequently the entity historically expressed interest in travelling, and the like for determining the weight for the given class. In some examples, the computing system 104 can generate and apply individual scores for each instance of the entity expressing interest in travelling, actually travelling or purchasing products or services related to travelling, and the like, and the computing system 104 can aggregate the scores for determining the weight for the given class.

At block 340, the computing system 104 determines, for each entity represented by the first set of data and for each entity represented by the second set of data, weighted edges that define relationships between each entity and a corresponding class. The weighted edges can represent likelihoods of each entity interacting with a corresponding class. For example, and for a first entity, the computing system 104 can generate a set of weighted edges based on the weights determined for the first entity and with respect to a set of classes associated with the first entity. For example, if the computing system 104 generated seven weights corresponding to seven classes with which the first entity has a relationship, then the computing system 104 can generate seven weighted edges corresponding to the seven weights. The computing system 104 can adjust each of the seven weighted edges based on the generated weights. For example, and for a particular weight of the seven generated weights, the computing system 104 can adjust characteristics of the corresponding weighted edge. For example, if the particular weight is relatively high, then the computing system 104 can adjust the weighted edge to increase a size (e.g., length, width, and the like), change a color, change a pattern, and the like for the corresponding weighted edge. The computing system 104 can adjust each of the seven weighted edges, and each of the weighted edges relating each entity to each corresponding class to indicate the likelihood of each entity interacting with the corresponding class.

At block 350, the computing system 104 generates a weighted interaction graph based on the weights and the weighted edges. The weighted interaction graph can include a set of first nodes, a set of second nodes, and a set of connections. The set of first nodes can include one or more nodes such that each node of the one or more nodes represents an entity represented by the first set of data, the second set of data, or the like. The set of second nodes can include one or more nodes such that each node of the one or more nodes represents a class received or inferred from the first set of data, the second set of data, or the like. The set of connections can include one or more connections that can each connect a node of the set of first nodes with one or more nodes of the set of second nodes (e.g., the set of connections can connect entity nodes to class nodes).

The computing system 104 can identify entities represented by the first set of entities and by the second set of entities. In some examples, the computing system 104 can generate the set of first nodes based on identifying the entities. For example, if the computing system 104 identifies four entities, then the computing system 104 can generate four nodes for the set of first nodes each corresponding to each of the four identified entities. In some examples, the computing system 104 can generate a separate weighted interaction graph for each identified entity. For example, if the computing system 104 identifies four entities, then the computing system 104 can generate four separate weighted interaction graphs corresponding to each of the identified entities. In other examples, the computing system 104 can generate a weighted interaction graph that includes each of the nodes of the set of first nodes. For example, the weighted interaction graph can include one or more nodes corresponding to the identified entities.

The computing system 104 can receive or infer classes represented by the first set of data and the second set of data. In some examples, the computing system 104 can generate the set of second nodes based on receiving or inferring the classes. For example, the computing system 104 can receive or infer 17 classes that may at least partially correspond to four entities (e.g., each entity can correspond to at least a subset of the 17 classes). The computing system 104 can generate 17 nodes, corresponding to the 17 classes, for the set of second nodes. In some examples, the computing system 104 generates a weighted interaction graph for each entity. In these examples, the computing system 104 can populate each weighted interaction graph with one entity node (e.g., of the set of first nodes) and corresponding class nodes (e.g., of the set of second nodes). In a particular example, the computing system 104 determines that nine nodes of the set of second nodes correspond to a particular node of the set of first nodes. Accordingly, the computing system 104 generates a weighted interaction graph that includes one node from the set of first nodes and nine nodes, connected to the one node, from the set of second nodes. In other examples, the computing system 104 generates a weighted interaction graph that includes the four nodes of the set of first nodes and the 17 nodes of the set of second nodes. In these examples, the computing system 104 can arrange the 17 nodes suitably for allowing the weighted interaction graph to indicate corresponding likelihoods of the entities represented by the four nodes interacting with the classes represented by the 17 nodes.

The computing system 104 can generate weighted connections that can connect each node of the set of first nodes to one or more nodes of the set of second nodes. For example, the computing system 104 can generate the weighted interaction graph including one entity node (e.g., of the first set of nodes) and four class nodes (e.g., of the second set of nodes). Additionally, the computing system 104 can generate weights for each of the classes corresponding to the four class nodes and with respect to the entity represented by the one entity node. The computing system 104 can apply weighted edges (e.g., determined with respect to the block 340) between the entity node and each of the four class nodes. For example, the computing system 104 can connect the entity node to a first node of the four class nodes, to a second node of the four class nodes, to a third node of the four class nodes, and to a fourth node of the four class nodes. The connections (e.g., the weighted edges) can indicate a likelihood of the entity interacting with the class. For example, the connection between the entity node and the first node of the four class nodes can be short, wide, or the like to indicate a relatively high likelihood of the entity interacting with the corresponding class, while the connection between the entity node and the second node of the four class nodes can be long, thin, or the like to indicate a relatively low likelihood of the entity interacting with the corresponding class.

While specific examples are described with respect to the nodes, connections, and the like with respect to the weighted interaction graph, other numbers of nodes, connections, weighted interaction graphs, and the like can be generated for other numbers of first entities, second entities, classes, and the like. The computing system 104 can generate a single weighted interaction graph representing each entity of the first set of entities and of the second set of entities, the computing system 104 can generate weighted interaction graphs for each entity of the first set of entities and of the second set of entities, or an intermediary thereof

Exemplary Flow for Generating a Weighted Interaction Graph with Incomplete Data

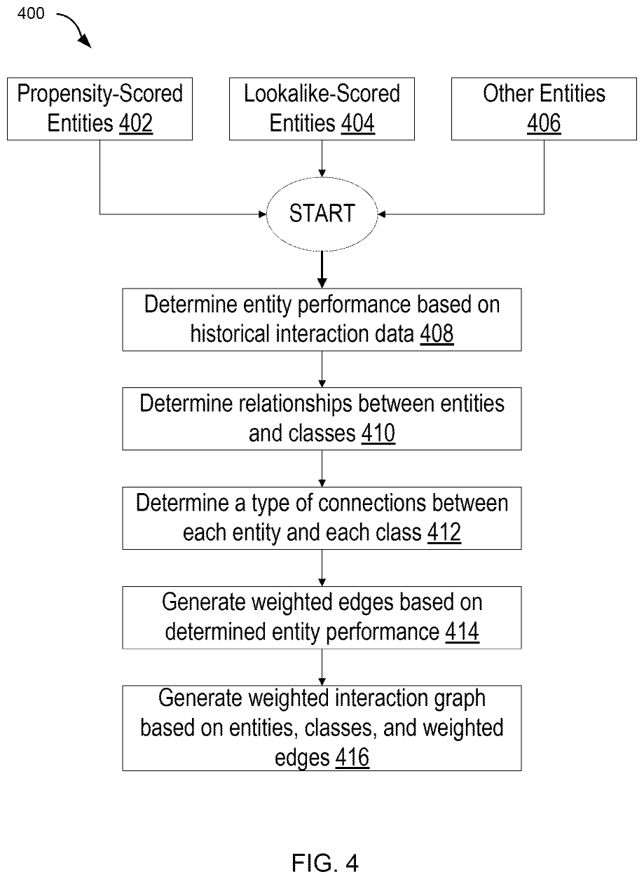

FIG. 4 is a data flow diagram 400 of data from disjunctive sources used for generating a weighted interaction graph according to an embodiment. The data flow diagram 400 may begin with propensity-scored entities 402, lookalike-scored entities 404, and other entities 406 being received by a computing device. Additionally, entities associated with the propensity-scored entities 402 may be at least partially different than entities associated with the lookalike-scored entities 404 and the other entities 406, or any permutation thereof. The propensity-scored entities 402 can include entities and/or classes that are or have been propensity scored, the lookalike-scored entities 404 can include entities and/or classes that are or have been lookalike-scored, and the other entities 406 can include unscored entities and/or classes that may not be represented by the propensity-scored entities 402 and/or the lookalike-scored entities 404.

At block 408, entity performance is determined based on historical interaction data. The historical interaction data can be included in the propensity-scored entities 402, the lookalike-scored entities 404, the other entities 406, and/or the entity data. The historical interaction data can include various information about interactions previously performed by entities. For example, the historical interaction data can include a type of the historical interactions, a class associated with the historical interactions, separate entities with which the entities interacted for executing the historical interactions, etc. A computing device can determine the entity performance by comparing the historical interaction data and the propensity-scored entities 402, the lookalike-scored entities 404, and/or the other entities 406. For example, entity performance can include whether an entity interacts with a class, how often the entity interacts with a class, how many resources have previously been involved with the entity interacting with the class, etc. In some examples, and for each entity, the entity performance can include a list of weighted performance scores for the entity with respect to each relevant class.

At block 410, relationships between entities and classes are determined. For example, the computing device can determine one or more relationships between (i) one or more entities represented by the propensity-scored entities 402, the lookalike-scored entities 404, the other entities 406, and/or the entity data and (ii) one or more classes represented by the propensity-scored entities 402, the lookalike-scored entities 404, and/or the other entities 406. In some examples, the computing device can analyze historical weights for each entity with respect to a particular class and can update the historical weight based on the entity performance determined at the block 408. Additionally, the computing device can query the entities to determine whether one or more entities with similar entity performances. In response to identifying a separate entity with a similar entity performance as the entity, the computing device can determine whether any highly weighted classes of the separate entity are not associated with the entity, are not highly weighted with the entity, etc. In response to identifying the highly weighted class of the separate entity, the computing device can generate a relationship between the entity and the highly weighted class with a median weighting based on a cross-entity weighting of the highly weighted class.

At block 412, types of connections are determined between each entity and each class. In some examples, the computing device can determine which classes are associated with a particular entity. Accordingly, the computing device can determine that the determined classes are connected to the particular entity. The computing device can generate a connection between each of the determined classes and the particular entity. In some examples, the connections can include edges, but other types connections can be generated by the computing device.

At block 414, weighted edges are generated based on the entity performance determined with respect to the block 408. The connections generated at the block 412 can be weighted based on the entity performance. For example, the entity performance can indicate that an entity more frequently interacts with a first class than a second class. Accordingly, a first connection between the entity and the first class and a second connection between the entity and the second class can indicate that the entity is more likely to interact with the first class than the second class. In some examples, the computing device can generate a weighted edge for each connection between each entity and corresponding classes.

At block 416, a weighted interaction graph is generated based at least on the entities, classes, and the weighted edges. The computing device can generate first nodes for each identified entity, second nodes for each received or inferred class, and connections that connect one or more first nodes with one or more second nodes. The computing device can generate a weighted interaction graph that includes the entities and classes, a weighted graph for each of the entities, or an intermediary thereof. For example, the computing device can generate a first node representing an entity and a set of second nodes representing classes associated with the entity. The computing device can apply the weighted edges determined at the block 414 to the first node and the set of second nodes. For example, the computing device can connect the first node and the set of second nodes with weighted edges corresponding to first node and each node of the set of second nodes. The weighted edges may differ between one another based on a likelihood of the entity interacting with corresponding classes.

In some examples, the weighted interaction graph can be used to enhance data. For example, data or metadata about entities not represented by the received entity data can be inferred from the weighted interaction graph. Additionally, missing data or metadata about entities represented by the received data can be inferred. In a particular example, the computing device can receive data about a first entity and can use the weighted interaction graph (e.g., by querying the weighted interaction graph to determine similar entities) to infer additional, previously inaccessible, data or metadata about the first entity. By inferring additional data or metadata, the computing device can use the weighted interaction graph to enhance existing data by generating an extended dataset. The extended dataset can include (i) additional data and/or metadata about entities represented by the received data, (ii) data and/or metadata about entities not represented by the received data, and/or (iii) higher quality data about the entities represented by the received data. In some examples, the extended set of data includes interaction data for the entities not inferable separately from the received data.

In some examples, the weighted interaction graph can be output. For example, the computing device can output the weighted interaction graph to facilitate communication with entities represented by the weighted interaction graph. In other examples, the computing device can output the weighted interaction graph for storage in a weighted interaction graph database. In yet other examples, the weighted interaction graph can be output for use in controlling resource access for one or more of the entities represented by the weighted interaction graph.

### Exemplary Weighted Interaction Graph

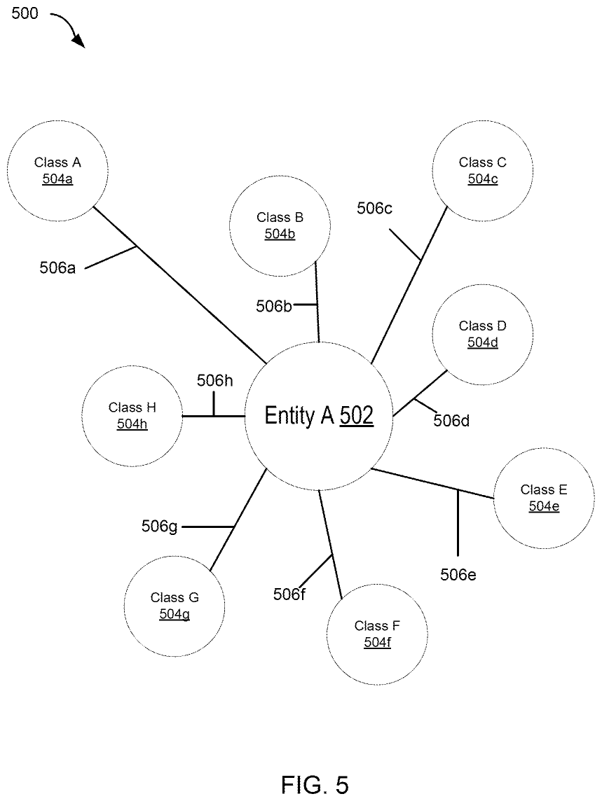

FIG. 5 is a diagram of one example of a weighted interaction graph 500 according to an embodiment. As illustrated, the weighted interaction graph 500 includes (i) nine nodes corresponding to one entity and eight classes and (ii) eight edges 506a-h connecting the one entity to the eight classes, though other numbers of entities, classes, nodes, edges, or a combination thereof can be included in the weighted interaction graph 500. The weighted interaction graph 500 includes a first node 502 that corresponds to entity A. Additionally, the weighted interaction graph 500 includes second nodes 504a-h corresponding to classes A-H, respectively. Additionally, the weighted interaction graph 500 includes the edges 506a-h corresponding to edges that connect the first node 502 to each of the second nodes 504a-h.

In some examples, the entity represented by the first node 502 can be related to each of the classes represented by the second nodes 504a-h. For example, the entity may interact with each of the classes based on a likelihood indicated by the edges 506a-h. In some examples, the edges 506a-h may be weighted and/or adjusted using the operations described with respect to the block 240 of the process 200, the block 330 of the process 300, and/or the block 414 of the data flow diagram 400. As illustrated, the edges 506a-h are weighted based on a length. For example second node 504a (representing class A) is much further from the first node 502 than second node 504b (representing class B), which indicates that the entity is more likely to interact with class B than with class A, etc. The weighted interaction graph 500 can otherwise suitably be generated for indicating likelihoods of the entity interacting with classes.

### Illustrative Systems

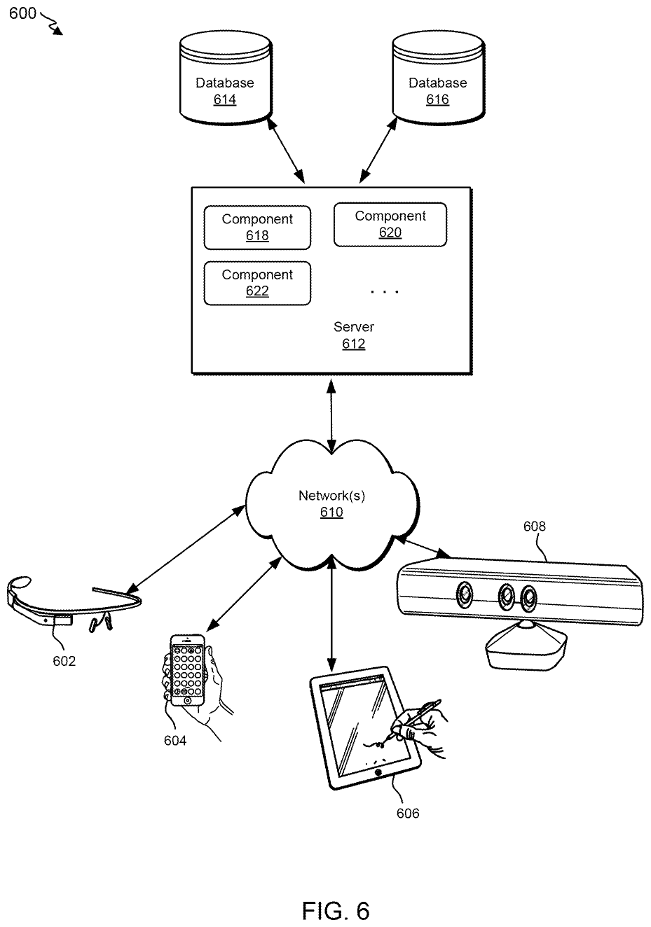

FIG. 6 depicts a simplified diagram of a distributed system 600 for implementing one of the embodiments. In the illustrated embodiment, distributed system 600 includes one or more client computing devices 602, 604, 606, and 608, which are configured to execute and operate a client application such as a web browser, proprietary client (e.g., Oracle Forms), or the like over one or more network(s) 610. Server 612 may be communicatively coupled with remote client computing devices 602, 604, 606, and 608 via network(s) 610.

In various embodiments, server 612 may be adapted to run one or more services or software applications provided by one or more of the components of the system. In some embodiments, these services may be offered as web-based or cloud services or under a Software as a Service (SaaS) model to the users of client computing devices 602, 604, 606, and/or 608. Users operating client computing devices 602, 604, 606, and/or 608 may in turn utilize one or more client applications to interact with server 612 to utilize the services provided by these components.

In the configuration depicted in the figure, the software components 618, 620 and 622 of distributed system 600 are shown as being implemented on server 612. In other embodiments, one or more of the components of distributed system 600 and/or the services provided by these components may also be implemented by one or more of the client computing devices 602, 604, 606, and/or 608. Users operating the client computing devices may then utilize one or more client applications to use the services provided by these components. These components may be implemented in hardware, firmware, software, or combinations thereof. It should be appreciated that various different system configurations are possible, which may be different from distributed system 600. The embodiment shown in the figure is thus one example of a distributed system for implementing an embodiment system and is not intended to be limiting.

Client computing devices 602, 604, 606, and/or 608 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 602, 604, 606, and 608 may be any other electronic device, such as a thin-client computer, an Internet-enabled gaming system (e.g., a Microsoft Xbox gaming console with or without a Kinect® gesture input device), and/or a personal messaging device, capable of communicating over network(s) 610.

Although exemplary distributed system 600 is shown with four client computing devices, any number of client computing devices may be supported. Other devices, such as devices with sensors, etc., may interact with server 612.

Network(s) 610 in distributed system 600 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 610 can be a local area network (LAN), such as one based on Ethernet, Token-Ring and/or the like. Network(s) 610 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 612 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 612 may be adapted to run one or more services or software applications described in the foregoing disclosure. For example, server 612 may correspond to a server for performing processing described above according to an embodiment of the present disclosure.

Server 612 may run an operating system including any of those discussed above, as well as any commercially available server operating system. Server 612 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 612 may include one or more applications to analyze and consolidate data feeds and/or event updates received from users of client computing devices 602, 604, 606, and 608. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 612 may also include one or more applications to display the data feeds and/or real-time events via one or more display devices of client computing devices 602, 604, 606, and 608.

Distributed system 600 may also include one or more databases 614 and 616. Databases 614 and 616 may reside in a variety of locations. By way of example, one or more of databases 614 and 616 may reside on a non-transitory storage medium local to (and/or resident in) server 612. Alternatively, databases 614 and 616 may be remote from server 612 and in communication with server 612 via a network-based or dedicated connection. In one set of embodiments, databases 614 and 616 may reside in a storage-area network (SAN). Similarly, any necessary files for performing the functions attributed to server 612 may be stored locally on server 612 and/or remotely, as appropriate. In one set of embodiments, databases 614 and 616 may include relational databases, such as databases provided by Oracle, that are adapted to store, update, and retrieve data in response to SQL-formatted commands.

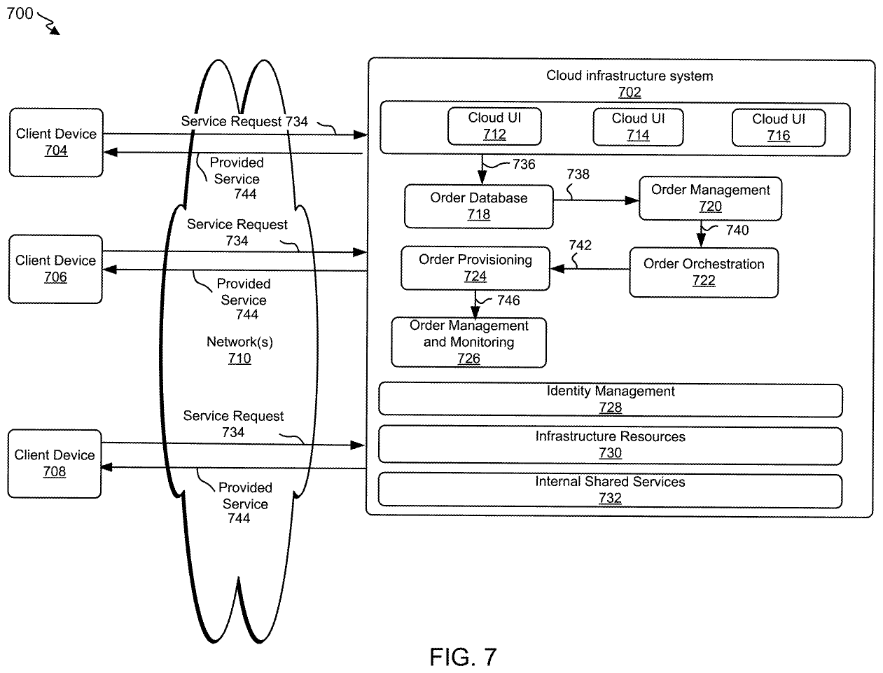

FIG. 7 is a simplified block diagram of one or more components of a system environment 700 by which services provided by one or more components of an embodiment system may be offered as cloud services, in accordance with an embodiment of the present disclosure. In the illustrated embodiment, system environment 700 includes one or more client computing devices 704, 706, and 708 that may be used by users to interact with a cloud infrastructure system 702 that provides cloud services. The client computing devices may be configured to operate a client application such as a web browser, a proprietary client application (e.g., Oracle Forms), or some other application, which may be used by a user of the client computing device to interact with cloud infrastructure system 702 to use services provided by cloud infrastructure system 702.

It should be appreciated that cloud infrastructure system 702 depicted in the FIG. may have other components than those depicted. Further, the embodiment shown in the figure is only one example of a cloud infrastructure system that may incorporate an embodiment of the invention. In some other embodiments, cloud infrastructure system 702 may have more or fewer components than shown in the figure, may combine two or more components, or may have a different configuration or arrangement of components.

Client computing devices 704, 706, and 708 may be devices similar to those described above for 602, 604, 606, and 608.

Although exemplary system environment 700 is shown with three client computing devices, any number of client computing devices may be supported. Other devices such as devices with sensors, etc. may interact with cloud infrastructure system 702.

Network(s) 710 may facilitate communications and exchange of data between clients 704, 706, and 708 and cloud infrastructure system 702. Each network may be any type of network familiar to those skilled in the art that can support data communications using any of a variety of commercially-available protocols, including those described above for network(s) 710.

Cloud infrastructure system 702 may comprise one or more computers and/or servers that may include those described above for server 612.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 702 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 702 may be adapted to automatically provision, manage and track a customer's subscription to services offered by cloud infrastructure system 702. Cloud infrastructure system 702 may provide the cloud services via different deployment models. For example, services may be provided under a public cloud model in which cloud infrastructure system 702 is owned by an organization selling cloud services (e.g., owned by Oracle) and the services are made available to the general public or different industry enterprises. As another example, services may be provided under a private cloud model in which cloud infrastructure system 702 is operated solely for a single organization and may provide services for one or more entities within the organization. The cloud services may also be provided under a community cloud model in which cloud infrastructure system 702 and the services provided by cloud infrastructure system 702 are shared by several organizations in a related community. The cloud services may also be provided under a hybrid cloud model, which is a combination of two or more different models.

In some embodiments, the services provided by cloud infrastructure system 702 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 702. Cloud infrastructure system 702 then performs processing to provide the services in the customer's subscription order.

In some embodiments, the services provided by cloud infrastructure system 702 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various cloud applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 702 may also include infrastructure resources 730 for providing the resources used to provide various services to customers of the cloud infrastructure system. In one embodiment, infrastructure resources 730 may include pre-integrated and optimized combinations of hardware, such as servers, storage, and networking resources to execute the services provided by the PaaS platform and the SaaS platform.

In some embodiments, resources in cloud infrastructure system 702 may be shared by multiple users and dynamically re-allocated per demand. Additionally, resources may be allocated to users in different time zones. For example, cloud infrastructure system 730 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 732 may be provided that are shared by different components or modules of cloud infrastructure system 702 and by the services provided by cloud infrastructure system 702. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 702 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 702, and the like.

In one embodiment, as depicted in the figure, cloud management functionality may be provided by one or more modules, such as an order management module 720, an order orchestration module 722, an order provisioning module 724, an order management and monitoring module 726, and an identity management module 728. These modules may include or be provided using one or more computers and/or servers, which may be general purpose computers, specialized server computers, server farms, server clusters, or any other appropriate arrangement and/or combination.

In exemplary operation 734, a customer using a client device, such as client device 704, 706 or 708, may interact with cloud infrastructure system 702 by requesting one or more services provided by cloud infrastructure system 702 and placing an order for a subscription for one or more services offered by cloud infrastructure system 702. In certain embodiments, the customer may access a cloud User Interface (UI), cloud UI 712, cloud UI 714 and/or cloud UI 716 and place a subscription order via these UIs. The order information received by cloud infrastructure system 702 in response to the customer placing an order may include information identifying the customer and one or more services offered by the cloud infrastructure system 702 that the customer intends to subscribe to.

After an order has been placed by the customer, the order information is received via the cloud UIs, 712, 714 and/or 716.

At operation 736, the order is stored in order database 718. Order database 718 can be one of several databases operated by cloud infrastructure system 718 and operated in conjunction with other system elements.

At operation 738, the order information is forwarded to an order management module 720. In some instances, order management module 720 may be configured to perform billing and accounting functions related to the order, such as verifying the order, and upon verification, booking the order.

At operation 740, information regarding the order is communicated to an order orchestration module 722. Order orchestration module 722 may utilize the order information to orchestrate the provisioning of services and resources for the order placed by the customer. In some instances, order orchestration module 722 may orchestrate the provisioning of resources to support the subscribed services using the services of order provisioning module 724.

In certain embodiments, order orchestration module 722 enables the management of processes associated with each order and applies logic to determine whether an order should proceed to provisioning. At operation 742, upon receiving an order for a new subscription, order orchestration module 722 sends a request to order provisioning module 724 to allocate resources and configure those resources needed to fulfill the subscription order. Order provisioning module 724 enables the allocation of resources for the services ordered by the customer. Order provisioning module 724 provides a level of abstraction between the cloud services provided by cloud infrastructure system 700 and the physical implementation layer that is used to provision the resources for providing the requested services. Order orchestration module 722 may thus be isolated from implementation details, such as whether or not services and resources are actually provisioned on the fly or pre-provisioned and only allocated/assigned upon request.

At operation 744, once the services and resources are provisioned, a notification of the provided service may be sent to customers on client devices 704, 706 and/or 708 by order provisioning module 724 of cloud infrastructure system 702.

At operation 746, the customer's subscription order may be managed and tracked by an order management and monitoring module 726. In some instances, order management and monitoring module 726 may be configured to collect usage statistics for the services in the subscription order, such as the amount of storage used, the amount data transferred, the number of users, and the amount of system up time and system down time.

In certain embodiments, cloud infrastructure system 700 may include an identity management module 728. Identity management module 728 may be configured to provide identity services, such as access management and authorization services in cloud infrastructure system 700. In some embodiments, identity management module 728 may control information about customers who wish to utilize the services provided by cloud infrastructure system 702. Such information can include information that authenticates the identities of such customers and information that describes which actions those customers are authorized to perform relative to various system resources (e.g., files, directories, applications, communication ports, memory segments, etc.) Identity management module 728 may also include the management of descriptive information about each customer and about how and by whom that descriptive information can be accessed and modified.

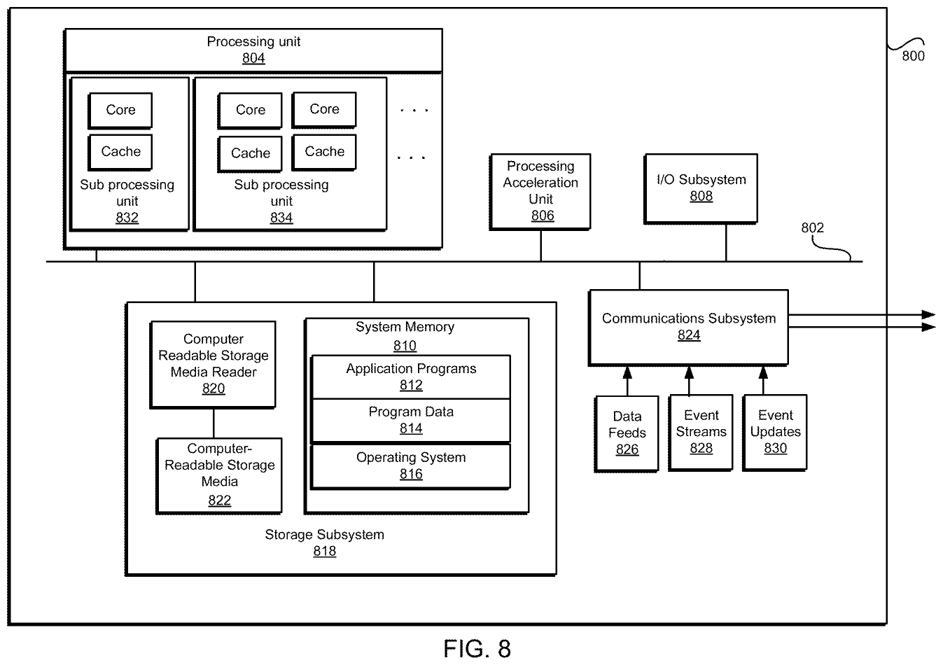

FIG. 8 illustrates an exemplary computer system 800, in which various embodiments of the present invention may be implemented. The system 800 may be used to implement any of the computer systems described above. As shown in the figure, computer system 800 includes a processing unit 804 that communicates with a number of peripheral subsystems via a bus subsystem 802. These peripheral subsystems may include a processing acceleration unit 806, an I/O subsystem 808, a storage subsystem 818 and a communications subsystem 824. Storage subsystem 818 includes tangible computer-readable storage media 822 and a system memory 810.

Bus subsystem 802 provides a mechanism for letting the various components and subsystems of computer system 800 communicate with each other as intended. Although bus subsystem 802 is shown schematically as a single bus, alternative embodiments of the bus subsystem may utilize multiple buses. Bus subsystem 802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 804, which can be implemented as one or more integrated circuits (e.g., a conventional microprocessor or microcontroller), controls the operation of computer system 800. One or more processors may be included in processing unit 804. These processors may include single core or multicore processors. In certain embodiments, processing unit 804 may be implemented as one or more independent processing units 832 and/or 834 with single or multicore processors included in each processing unit. In other embodiments, processing unit 804 may also be implemented as a quad-core processing unit formed by integrating two dual-core processors into a single chip.

In various embodiments, processing unit 804 can execute a variety of programs in response to program code and can maintain multiple concurrently executing programs or processes. At any given time, some or all of the program code to be executed can be resident in processor(s) 804 and/or in storage subsystem 818. Through suitable programming, processor(s) 804 can provide various functionalities described above. Computer system 800 may additionally include a processing acceleration unit 806, which can include a digital signal processor (DSP), a special-purpose processor, and/or the like.

I/O subsystem 808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 800 may comprise a storage subsystem 818 that comprises software elements, shown as being currently located within a system memory 810. System memory 810 may store program instructions that are loadable and executable on processing unit 804, as well as data generated during the execution of these programs.

Depending on the configuration and type of computer system 800, system memory 810 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 804. In some implementations, system memory 810 may include multiple different types of memory, such as static random access memory (SRAM) or dynamic random access memory (DRAM). In some implementations, a basic input/output system (BIOS), containing the basic routines that help to transfer information between elements within computer system 800, such as during start-up, may typically be stored in the ROM. By way of example, and not limitation, system memory 810 also illustrates application programs 812, which may include client applications, Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 818 may also provide a tangible computer-readable storage medium for storing the basic programming and data constructs that provide the functionality of some embodiments. Software (programs, code modules, instructions) that when executed by a processor provide the functionality described above may be stored in storage subsystem 818. These software modules or instructions may be executed by processing unit 804. Storage subsystem 818 may also provide a repository for storing data used in accordance with the present invention.

Storage subsystem 800 may also include a computer-readable storage media reader 820 that can further be connected to computer-readable storage media 822. Together and, optionally, in combination with system memory 810, computer-readable storage media 822 may comprehensively represent remote, local, fixed, and/or removable storage devices plus storage media for temporarily and/or more permanently containing, storing, transmitting, and retrieving computer-readable information.

Computer-readable storage media 822 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 800.

By way of example, computer-readable storage media 822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to connect to one or more devices via the Internet. In some embodiments communications subsystem 824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 1202.11 family standards, or other mobile communication technologies, or any combination thereof), global positioning system (GPS) receiver components, and/or other components. In some embodiments communications subsystem 824 can provide wired network connectivity (e.g., Ethernet) in addition to or instead of a wireless interface.

In some embodiments, communications subsystem 824 may also receive input communication in the form of structured and/or unstructured data feeds 826, event streams 828, event updates 830, and the like on behalf of one or more users who may use computer system 800.

By way of example, communications subsystem 824 may be configured to receive data feeds 826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 824 may also be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 824 may also be configured to output the structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A computer-implemented method comprising:
receiving, at a computing device and from a first source of data, a first set of data that includes data about a first set of entities;
receiving, by the computing device and from a second source of data that is different than the first source of data, a second set of data that includes data about a second set of entities that is at least partially different than the first set of entities;
determining, by the computing device and based on the first set of data and the second set of data, a set of relationships between each entity of the first set of entities and the second set of entities and a set of classes inferred from the first set of data and from the second set of data;
generating, by the computing device and using the set of relationships, a weighted interaction graph that indicates, for each entity of the first set of entities and the second set of entities, a likelihood of each entity interacting with a corresponding class;
generating, by the computing device and using the weighted interaction graph, an extended set of data; and
outputting the extended set of data to facilitate communication with a third set of entities that comprises a plurality of entities from the first set of entities and a plurality of entities from the second set of entities that are not included in the first set of entities.

2. The computer-implemented method of claim 1, wherein the first source of data is disjunctive with respect to the second source of data.

3. The computer-implemented method of claim 1, wherein determining the set of relationships comprises, for each entity included in the first set of entities and in the second set of entities:
receiving, by the computing device, historical interaction data; and
determining, by the computing device and using the historical interaction data, a plurality of relationships between the entity and a plurality of classes.

4. The computer-implemented method of claim 3, wherein each relationship included in the plurality of relationships comprises a likelihood of the entity interacting with a corresponding class of the plurality of classes.

5. The computer-implemented method of claim 1, wherein the first set of data includes propensity-scored entities, wherein the second set of data includes look-a-like-scored entities, and wherein the computer-implemented method further comprises receiving, by the computing device, a third set of data, which includes unscored entities and that is at least partially different than the first set of data and the second set of data, from a third source of data that is different than the first source of data and the second source of data.

6. The computer-implemented method of claim 5, wherein determining the set of relationships between each entity of the first set of entities and the second set of entities and the set of classes inferred from the first set of data and from the second set of data comprises determining, by the computing device, the set of relationships between each entity of the first set of entities, the second set of entities, and the unscored entities and a different set of classes inferred from the first set of data, from the second set of data, and from the third set of data.

7. The computer-implemented method of claim 1, wherein the extended set of data includes interaction data not inferable separately from the first set of data and the second set of data.

8. A non-transitory machine-readable storage medium comprising a computer-program product that includes instructions configured to cause a data processing apparatus to perform operations comprising:
receiving, at a computing device and from a first source of data, a first set of data that includes data about a first set of entities;
receiving, by the computing device and from a second source of data that is different than the first source of data, a second set of data that includes data about a second set of entities that is at least partially different than the first set of entities;
determining, by the computing device and based on the first set of data and the second set of data, a set of relationships between each entity of the first set of entities and the second set of entities and a set of classes inferred from the first set of data and from the second set of data;
generating, by the computing device and using the set of relationships, a weighted interaction graph that indicates, for each entity of the first set of entities and the second set of entities, a likelihood of each entity interacting with a corresponding class;
generating, by the computing device and using the weighted interaction graph, an extended set of data; and
outputting the extended set of data to facilitate communication with a third set of entities that comprises a plurality of entities from the first set of entities and a plurality of entities from the second set of entities that are not included in the first set of entities.

9. The non-transitory machine-readable storage medium of claim 8, wherein the first source of data is disjunctive with respect to the second source of data.

10. The non-transitory machine-readable storage medium of claim 8, wherein the operation of determining the set of relationships comprises, for each entity included in the first set of entities and in the second set of entities:
receiving historical interaction data; and
determining, by using the historical interaction data, a plurality of relationships between the entity and a plurality of classes.

11. The non-transitory machine-readable storage medium of claim 10, wherein each relationship included in the plurality of relationships comprises a likelihood of the entity interacting with a corresponding class of the plurality of classes.

12. The non-transitory machine-readable storage medium of claim 8, wherein the first set of data includes propensity-scored entities, wherein the second set of data includes look-a-like-scored entities, and wherein the operations further comprise receiving a third set of data, which includes unscored entities and that is at least partially different than the first set of data and the second set of data, from a third source of data that is different than the first source of data and the second source of data.

13. The non-transitory machine-readable storage medium of claim 12, wherein the operation of determining the set of relationships between each entity of the first set of entities and the second set of entities and the set of classes inferred from the first set of data and from the second set of data comprises determining the set of relationships between each entity of the first set of entities, the second set of entities, and the unscored entities and a different set of classes inferred from the first set of data, from the second set of data, and from the third set of data.

14. The non-transitory machine-readable storage medium of claim 8, wherein the extended set of data includes interaction data not inferable separately from the first set of data and the second set of data.

15. A system, comprising:
one or more data processors; and
a non-transitory computer-readable storage medium containing instructions which, when executed on the one or more data processors, cause the one or more data processors to perform operations comprising:
receiving, at a computing device and from a first source of data, a first set of data that includes data about a first set of entities;
receiving, by the computing device and from a second source of data that is different than the first source of data, a second set of data that includes data about a second set of entities that is at least partially different than the first set of entities;
determining, by the computing device and based on the first set of data and the second set of data, a set of relationships between each entity of the first set of entities and the second set of entities and a set of classes inferred from the first set of data and from the second set of data;
generating, by the computing device and using the set of relationships, a weighted interaction graph that indicates, for each entity of the first set of entities and the second set of entities, a likelihood of each entity interacting with a corresponding class;
generating, by the computing device and using the weighted interaction graph, an extended set of data; and
outputting the extended set of data to facilitate communication with a third set of entities that comprises a plurality of entities from the first set of entities and a plurality of entities from the second set of entities that are not included in the first set of entities.

16. The system of claim 15, wherein the operation of determining the set of relationships comprises, for each entity included in the first set of entities and in the second set of entities:
receiving historical interaction data; and
determining, by using the historical interaction data, a plurality of relationships between the entity and a plurality of classes.

17. The system of claim 16, wherein each relationship included in the plurality of relationships comprises a likelihood of the entity interacting with a corresponding class of the plurality of classes.

18. The system of claim 15, wherein the first set of data includes propensity-scored entities, wherein the second set of data includes look-a-like-scored entities, and wherein the operations further comprise receiving a third set of data, which includes unscored entities and that is at least partially different than the first set of data and the second set of data, from a third source of data that is different than the first source of data and the second source of data.

19. The system of claim 18, wherein the operation of determining the set of relationships between each entity of the first set of entities and the second set of entities and the set of classes inferred from the first set of data and from the second set of data comprises determining the set of relationships between each entity of the first set of entities, the second set of entities, and the unscored entities and a different set of classes inferred from the first set of data, from the second set of data, and from the third set of data.

20. The system of claim 15, wherein the first source of data is disjunctive with respect to the second source of data, and wherein the extended set of data includes interaction data not inferable separately from the first set of data and the second set of data.
